(19) United States
(12) Patent Application Publication
(10) Pub. No.: US 2016/0100439 A1
(43) Pub. Date: Apr. 7, 2016

(54) Techniques for Determining Identity Information Used for Wireless Communications

(71) Applicant: Under Armour, Inc., Baltimore, MD (US)

(72) Inventors: Mark A. Oleson, Baltimore, MD (US); F. Grant Kovach, Baltimore, MD (US); Lauryn Fantano, Baltimore, MD (US)

(73) Assignee: Under Armour, Inc., Baltimore, MD (US)

(21) Appl. No.: 14/505,877

(22) Filed: Oct. 3, 2014

(51) Int. Cl. H04W 76/02; H04W 12/06; H04L 29/06; H04B 5/00

(52) U.S. Cl. CPC H04W 76/021; H04W 76/023; H04B 5/0062; H04W 12/06; H04L 63/083

(57) ABSTRACT

Techniques are presented herein for optimizing identification and pairing of devices for wireless communications. A first device is configured to interact with a detection region of a second device. The first device detects the detection region associated with the second device and obtains information from the detecting. The first device analyzes the information to determine identity information of the second device. The identity information comprises information configured to be utilized during pairing of the first device and the second device for wireless communications between the first device and the second device.

### TECHNICAL FIELD

The present disclosure relates to techniques for optimizing pairing of devices for wireless communications.

### BACKGROUND

Electronic devices are becoming increasingly prevalent in products across industries. Often, these devices may need to communicate with each other in order to exchange and retrieve information. Electronic devices may be arranged in a network to allow an exchange of messages (e.g., packets). The devices may, for example, communicate over a wireless network using one or more wireless protocols. For example, the devices may communicate over a wireless network in accordance with the Institute for Electrical and Electronics Engineers (IEEE) 802.11 standard (e.g., Wi-Fi) protocol, Bluetooth protocol, Bluetooth® Low Energy pit etc. When the devices communicate one another, the devices may need to associate or “pair” with each other before messages can be exchanged. Often, identity information of each device is exchanged to devices during the pairing process.

### BRIEF DESCRIPTION OF THE DRAWINGS

FIG. 1 shows an example system with a first electronic device configured to obtain identity information from a second electronic device for wireless communication pairing.

FIG. 2 shows an example depiction of the first electronic device reading an image associated with the second electronic device to obtain the identity information of the second electronic device.

FIG. 3 shows an example depiction of the first electronic device scanning a radio frequency tag associated with the second electronic device to obtain the identity information of the second electronic device.

FIG. 4 shows an example message diagram depicting the identity information obtained by the first electronic device before pairing operations are initiated between the first electronic device and the second electronic device.

FIG. 5 shows an example flow chart depicting operations of the first electronic device obtaining the identity information from the second electronic device.

FIG. 6 shows an example block diagram of the first electronic device configured to obtain the identity information from the second electronic device.

### DESCRIPTION OF EXAMPLE EMBODIMENTS

### Overview

Techniques are presented herein for optimizing identification and pairing of devices for wireless communications. A first device is configured to interact with a detection region of a second device. The first device detects the detection region associated with the second device and obtains information from the detecting. The first device analyzes the information to determine identity information of the second device. The identity information comprises information configured to be utilized during pairing of the first device and the second device for wireless communications between the first device and the second device.

### Example Embodiments

The techniques presented herein involve optimizing identification and pairing of devices for wireless communications. For example, the techniques described herein enable electronic devices to receive identity information before (a priori) pairing operations are initialized for wireless communications, thus improving the functioning of the electronic devices. Additionally, by enabling electronic de ices to receive identity information before pairing operations are initialized, the electronic devices can more efficiently detect and communicate wirelessly with other electronic devices.

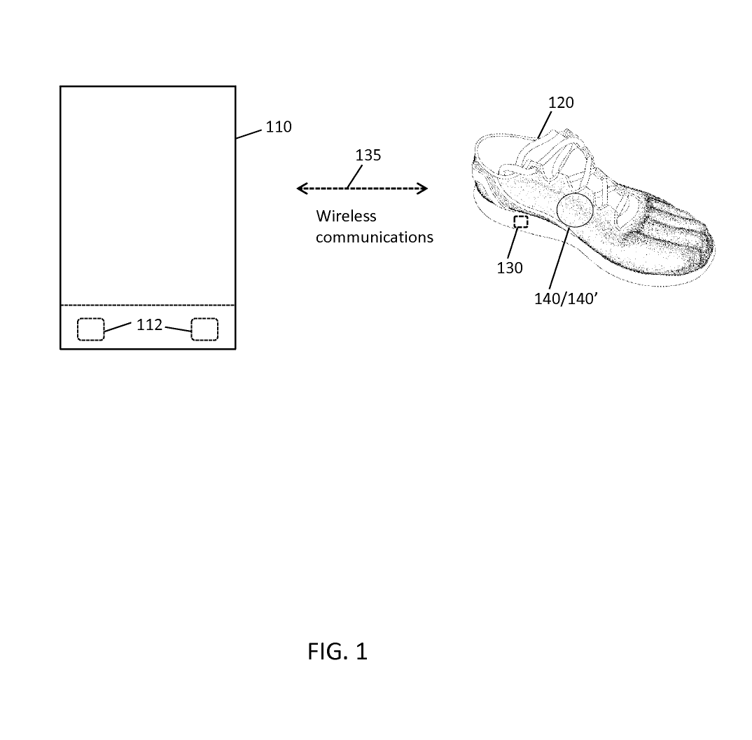

An example system topology (hereinafter “system”) is shown at reference numeral 100 in FIG. 1. The system 100 shows a first object 110 and a second object 120. In one example, the first object 110 and/or the second object 120 may he electronic devices. In another example, the first object 110 and/or the second object 120 may be non-electronic devices to which an electronic device is affixed, attached, housed or embedded (or otherwise in communication) (e.g., an associated electronic device”). Also in another example, one of the first object 110 or second object 120 may be an electronic device while the other of the first object 110 or second object 120 may be a non-electronic device with an associated electronic device. For simplicity, system 100 is described in the example where the first object 110 is an electronic device and the second object 120 is a non-electronic device with an associated electronic device therein. It should be appreciated that this is merely an example, and the techniques described herein are applicable regardless of whether the first object 110 and/or the second object 120 are electronic devices or non-electronic devices with associated electronic devices.

In the example of FIG. 1, the first object 110 is also referred to herein as a “first electronic device” or “first device.” For example, the first electronic device 110 may be a computing device with wireless communication capabilities (e.g., a mobile phone, tablet, desktop or other computing device). The second object 120 is shown demonstratively as a shoe. It should be appreciated that this is merely an example, and the description of the second object 120 herein is applicable to other non-electronic devices (e.g., articles of clothing, garments, sporting apparel, sporting equipment, or other non-electronic devices) or electronic devices with other associated electronic devices. For simplicity, the first object 110 is shown as a mobile phone (e.g., a “smart phone” with dashed buttons or icons 112) and the second object 120 is shown as a shoe. The second object 120 (shoe) has an associated electronic device embedded within it. The associated electronic device is shown at reference numeral 130. The associated electronic device 130 is shown with dashed lines to indicate that it may not be visible from the outside of the shoe. In other words, the associated electronic device 130 may be embedded within the shoe or otherwise placed within the shoe and/or surrounded by outer portions of the shoe. The associated electronic device 130 is also referred to herein as a “second electronic device” or “second device.” In one example, the second electronic device 130 may be micro-electro mechanical system (MEMS) device such as a sensor (e.g., an accelerometer, gyroscope, force sensor, magnetometer, tilt device, etc.), an actuator, etc. It should be appreciated that the second electronic device 130 may be affixed, attached, housed, embedded or in communication with the second object 120. As will be described herein, the second electronic device 130 is configured to communicate wirelessly with the first electronic device 110 by, for example, pairing with the first electronic device 110 and exchanging information (e.g., messages or packets) with the first electronic device 110 in accordance with a known or heretofore contemplated wireless communication standard. A general depiction of wireless communications between the first electronic device 110 and the second electronic device 130 is shown at reference numeral 135 in FIG. 1.

The system 100 also shows the second object 120 having a detection region. The detection region is shown at reference numeral 140/140′. In one example, the detection region 140/140′ may be attached or affixed to the second object 120. In another example, the detection region 140/140′ may be removed from or located distant from the second object 120. When attached to the second object 120, the detection region 140/140′ might not be delineated or readily identified. Thus, the detection region 140/140′ is shown with dashed lines. The detection region 140/140′ is associated with the second electronic device 130.

As will become apparent hereinafter, the detection region 140/140 may be, for example, an image, a radio frequency (RF) detection region (including, for example, an RF identification (RFID) tag, a near field communication (NFC) tag, or any RF tag), a color region, etc. For example, when the detection region 140/140′ is an image, the image may comprise a single dimension bar code or a multi-dimension bar code. In one example, the image is a Quick Response (QR) code (or other two-dimensional code). In this example, the QR code in FIG. 1 is configured to be detected by an electronic device (e.g., the first electronic device 110). For example, a camera on the first electronic device 110 may capture a picture of the QR code. Upon detecting the QR code, the first electronic device 110 may analyze the image and determine from analyzing the image identity information of the second electronic device 130. These techniques are described in more detail herein. It should be appreciated that the image may be any image that is configured to be captured or detected by an, electronic device and that is configured to provide to the electronic device (e.g., via information embedded or represented by contents of the image) identity information of an object (e.g., the second object 120, the second electronic device 130 or other object and/or device not shown in FIG. 1).

In another example, when the detection region 140/140′ is an RF detection region, the RF detection region may comprise an RFID tag or an NFC tag (or both). Thus, the first electronic device 110 may communicate with the second electronic device 130 through existing or heretofore contemplated RF communication protocols. For example, the first electronic device 110 may receive information represented by the RF detection region and may analyze the information received from the RF detection region to determine the identity information of the second electronic device 130.

In a third example, the detection region 140/140′ may be a color region of the second object 120. The first electronic device 110 may capture information about the color region of the second object 120, and from capturing such information, the first electronic device 110 may obtain identity information of the second electronic device. For example, a first color of the second object 120 may correspond to one or more identity information entries belonging in a first set, a second color of the second object 120 may correspond to one or more identity information entries belonging in a second set, and so on.

As stated above, the first electronic device 110 and the second electronic device 130 are electronic devices configured to exchange wireless communications with each other. For example, the first electronic device 110 and the second electronic device 130 are electronic devices configured to exchange wireless communications in accordance to a Bluetooth® protocol, institute for Electrical and Electronics Engineers (IEEE) 802.11 standard protocol, and/or other wireless communication standards known or contemplated. For example, the first electronic device 110 and the second electronic device 130 may communicate with each other within a piconet or a Personal Area Network (PAN). In one example, the techniques as described herein improve the functioning of the first electronic device 110 by enabling the first electronic device 110 to obtain identity information of the second electronic device 130 prior to an initialization (e.g., by the first electronic device 110, the second electronic device 130 or other device not shown in the system 100) of a pairing operation for wireless communications between the first electronic device 110 and the second electronic device 130. Additionally, the techniques as described herein improve wireless pairing operations by enabling the first electronic device 110 to receive the identity information a priori before the pairing operations. Thus, the first electronic device 110 already has the identity information of the second electronic device 130 before any pairing operations begin, and the two devices can more efficiently pair with each other for wireless communications. These techniques are described in more detail herein.

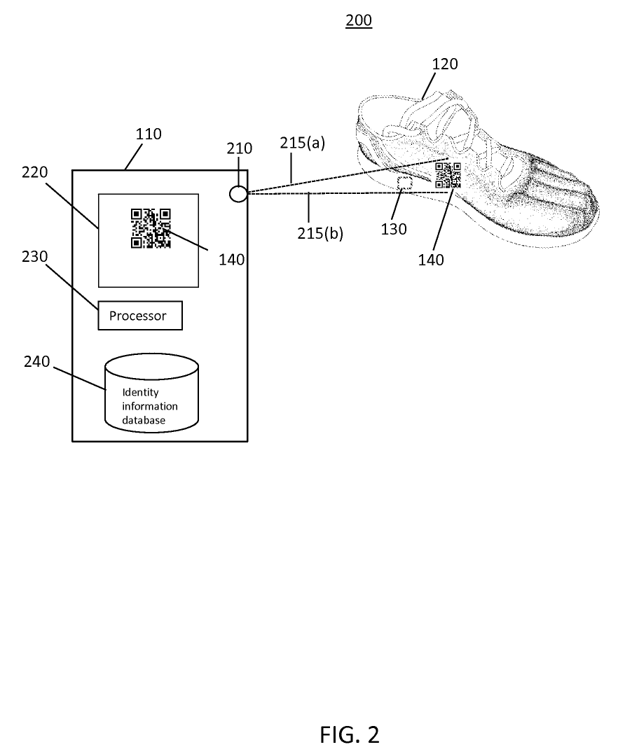

Reference is now made to FIG. 2. FIG. 2 shows an example depiction 200 of the first electronic device 110 reading the detection region associated with the second electronic device 130 to obtain identity information of the second electronic device 130. In FIG. 2, the detection region is shown as an image and has a reference numeral 140. The first electronic device 110 has an image capturing unit (e.g., a camera or a scanner) 210 that is configured to capture images. The camera 210 captures the image 140 (which is shown demonstratively in FIG. 2 as a QR code). The capturing is depicted generally by the field of capture lines 215(a) and 215(b) in FIG. 2. The image 140 is optionally displayed on the first electronic device 110 using an image display unit 220 (e.g., a screen) of the first electronic device 110. Upon capturing the image 140, a processor 230 of the first electronic device 110 analyzes the information in the image 140 to determine identity information of the second electronic device 130. In one example, the first electronic device 110 is configured to read the QR code and to determine from the QR code identity information of the second electronic device 130 (e.g., based on information contained in the QR code). The identity information may be encrypted and may require the processor 230 to perform decrypting operations before ascertaining the identity information.

After the processor 230 determines the identity information associated with the second electronic device 130, the processor 230 stores the identity information in an identity information database, shown at reference numeral 240 in FIG. 2. The identity information database 240 may be a memory component of the first electronic device 110 or may be located remotely (e.g., a remote or cloud-based database) but that is accessible by the processor 230 of the first electronic device 110. In general, the identity information database 240 stores identity information of the second electronic device 130. The identity information database 240 may also store identity information associated with other electronic devices. Thus, each time the first electronic device 110 captures an image with identity information contained therein, the identity information may be stored in and retrieved from the identity information database 240.

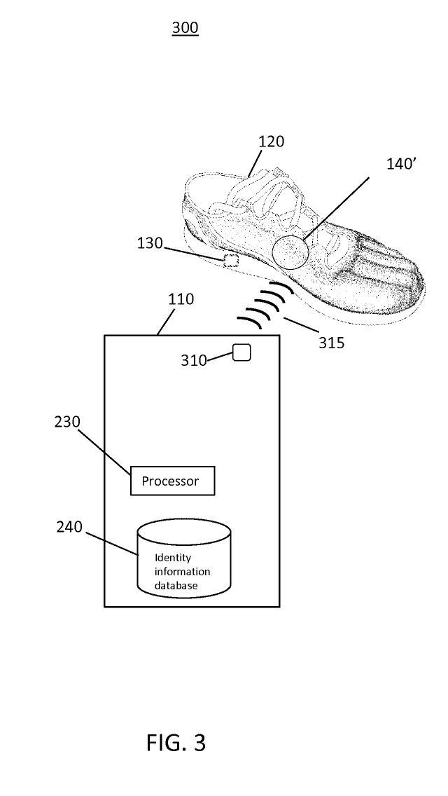

Reference is now made to FIG. 3, which shows an example depiction 300 of the first electronic device 110 scanning an RF detection region associated with the second electronic device 130 to obtain the identity information of the second electronic device 130. In FIG. 3, the detection region is shown as the RF detection region, shown generally at reference numeral 140′. As stated above, it should be appreciated that the RF detection region 140″ is any RF id tag (such as an RFID tag or an NFC tag) that enables RF communications between the first electronic device 110 and the second electronic device 130. These RF communications are shown generally in FIG. 3 at reference numeral 315. In the example in FIG. 3, the first electronic device 110 has a radio transceiver unit 310 that is configured to detect the RF detection region 140′. As shown, in one example, the first electronic device 110 may be held proximate the RF detection region 140′, and when the distance between the radio receiver and the RF detection region 140′ is at an appropriate distance, the first electronic device 110 detects (e.g., “reads”) the RF detection region 140′. The first electronic device 110 subsequently obtains information from the RF detection region 104′, including, for example, the identity information of the second electronic device 130. It should be appreciated that, in one example, the detection of the RF detection region 140′ by the first electronic device 110 is similar to RF detection techniques known or contemplated (such as RFID, NEC, etc.). Similar to the description provided in FIG. 2, upon receiving the identity information, the processor 230 analyzes the information provided by the RF detection region 140′ to determine the identity information of the second electronic device 130. The processor 230 may then store the identity information in the identity information database 240, as described in connection with FIG. 2, above.

In general, the identity information contains information associated with the second electronic device 130 as well as the second object 120. For example, the identity information may comprise identity information (e.g., a Unique Device Identifier (UDID) or other identifier) of an electronic device (e.g., a sensor in the shoe). The identity information may be used during wireless pairing operations, such as Bluetooth® pairing, between the sensor and the first electronic device 110 (mobile phone). The identity information may also comprise a serial number that is associated with the sensor. Additionally, the identity information may contain product related information about the shoe itself. For example, in addition to containing identity information such as a UDID or serial number, the identity information may comprise product information (such as shoe size, shoe type, shoe color, age, brand, utility information, etc.) of the shoe.

In a demonstrative example, a runner may plan to wear the shoe 120 during a race. Before the race, the runner (“user”) or another individual may utilize the mobile phone 110 to interact with the detection region 140/140′. For example, the mobile phone 110 may capture the image 140 (in the example of FIG. 2) or may detect the RF detection region 140′ (in the example of FIG. 3). In another example, the mobile phone 110 may capture a color region of the shoe, as described above. After interacting with the detection region 140/140′, the mobile phone 110 is able to obtain identity information of the sensor 130 in the shoe 120, and this identity information can later be used by the mobile phone 110 to pair with the sensor 130. That is, when the race starts, the user may pair his or her mobile phone 110 with the sensor 130 so that the mobile phone 110 can, for example, track the user's speed, distance, cadence, pace, etc. during the run. Since the mobile phone 110 has already obtained and stored the identity information of the sensor 130 a priori (that is, before the actual pairing operations were initiated), the mobile phone 110 can access the identity information database 240 during pairing operations without having to retrieve it from the sensor 130 and/or without waiting for the sensor to send/advertise the identity information. That is, the mobile phone 110 already knows the pairing information that it needs to successfully pair with the sensor 130 before the pairing operations were initiated.

In one example, the mobile phone 110 obtains the identity information of the sensor 130 based on information obtained and analyzed from the detection region 140/140′, and not based on resources accessible by the mobile phone 110 upon analyzing the detection region 140/140′. For example, when the detection region 140/140′ is an image, the image may be a QR code that, upon detection by the mobile phone 110, causes the mobile phone 110 to access a website or other information associated with a Uniform Resource Locator (URL). In one embodiment, the mobile phone 110 may obtain the identifier information of the sensor 130 directly from the images/designs (e.g., content) within the QR code and not from the website or URL associated with the QR code. In other words, the identifier information may be embedded within the visual depiction of the QR code itself without needing to be accessible via a website represented by the QR code. When the detection region 140/140′ is an RF detection region (e.g., an RF tag), the identifier information may be sent to the mobile phone 110 upon the mobile phone 110 detecting (reading) the RF detection region.

Additionally, when the user interacts with the detection region 140/140′ with his or her mobile phone 110, the mobile phone 110 may receive information about the shoe itself (e.g., product information). For example, the mobile phone 110 may receive information about the shoe type, color, size, brand, style, age, model, etc. This information can be used for inventory tracking, purchase tracking and product correlation operations between the shoe type and the information capture during pairing (e.g., correlating the shoe type to speed, distance, pace, overall performance, etc. measurements during the race). Thus, in general, the detection region 140/140′ has contained within it, or determinable from it, identity information utilized during pairing for the mobile phone 110 and the sensor 130 for wireless communications between the mobile phone 110 and the sensor 130, as well as product information of an object (shoe) with which the sensor is affixed, attached, housed, embedded or otherwise in communication.

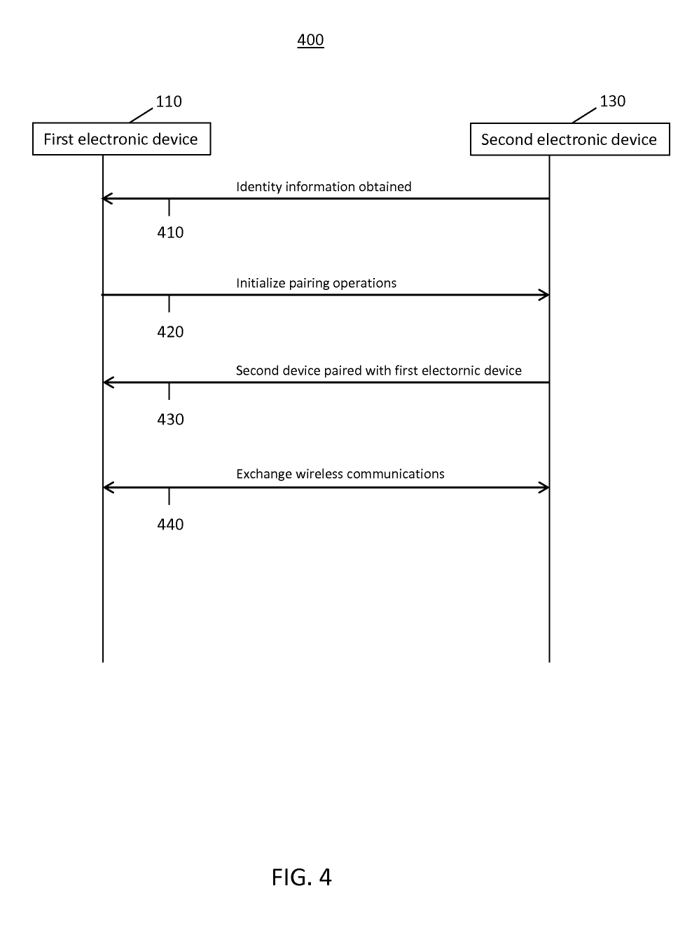

Reference is now made to FIG. 4. FIG. 4 shows an example message diagram 400 showing the identity information obtained by the first electronic device 110 before pairing operations are initiated between the first electronic device 110 and the second electronic device 130. At 410, identity information is obtained by the first electronic device 110 from the second electronic device 130. The identity information 410 comprises, among other elements, identity information used during pairing operations between the first electronic device 110 and the second electronic device 130. The first electronic device 110 obtains the identity information in accordance to one of the techniques described above. At 420, the first electronic device 110 initializes a pairing for wireless communications with the second electronic device 130. It should be appreciated that this pairing may be initialized by the second electronic device 130 as well. It should further be appreciated that the pairing operations represented by reference numeral 420 are pairing operations for wireless communications that are commonly known or heretofore contemplated (e.g., such as Bluetooth® pairing, other wireless pairing, etc.). Thus, for simplicity, the pairing operations are shown generally at reference numeral 420. At reference numeral 430, the second electronic device 130 pairs with the first electronic device 110, and at 440, wireless communications can be exchanged between the first electronic device 110 and the second electronic device 130.

It should be appreciated that FIG. 4 shows an improvement upon current pairing techniques for wireless communications. For example, current pairing techniques may require that the identity information be ascertained by the first electronic device 110 during the pairing operations 420. In the example shown in. FIG. 4, the identity information is obtained by the first electronic device 110 prior to the pairing operations 420 being initialized. That is, the first electronic device 110 received the identity information of the second electronic device 130 prior to pairing operations being initiated and stored the identity information of the second electronic device 130 in the identity information database 240. The first electronic device 110 retrieved the identity information of the second electronic device 130 when the second electronic device 130 initiated the pairing operations. Thus, by receiving the identity information before the pairing operations, the first electronic device 110 experiences improved computing and processing performance.

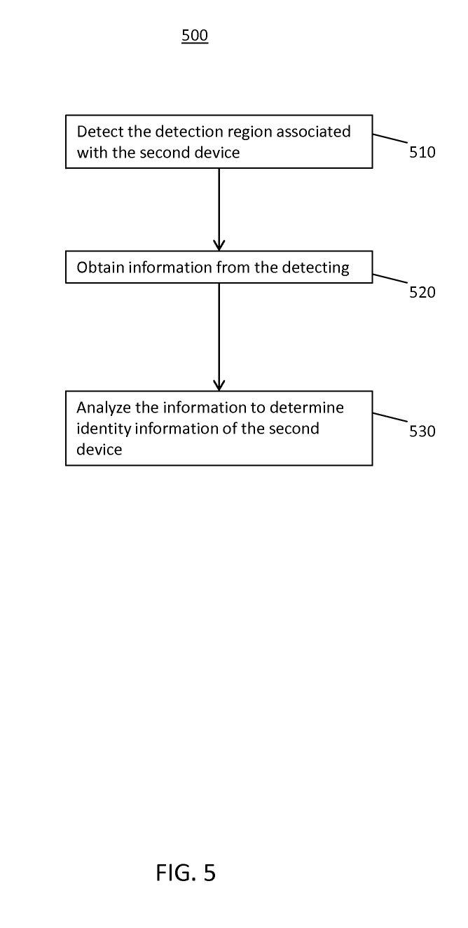

Reference is now made to FIG. 5. FIG. 5 shows a flow chart 500 depicting operations of the first electronic device 110 obtaining identity information from the second electronic device 130. At operation 510, the that electronic device 110, configured to interact with the detection region 140/140′, detects the detection region 140/140′ of the second electronic device 130. At operation 520, the first electronic device 110 obtains information from the detecting. At operation 530, the first electronic device 110 analyzes the information to determine identity information of the second electronic device 130. The identity information comprises information configured to be utilized during pairing of the First electronic device 110 and the second electronic device 130 for wireless communications between the first electronic device 110 and the second electronic device 130.

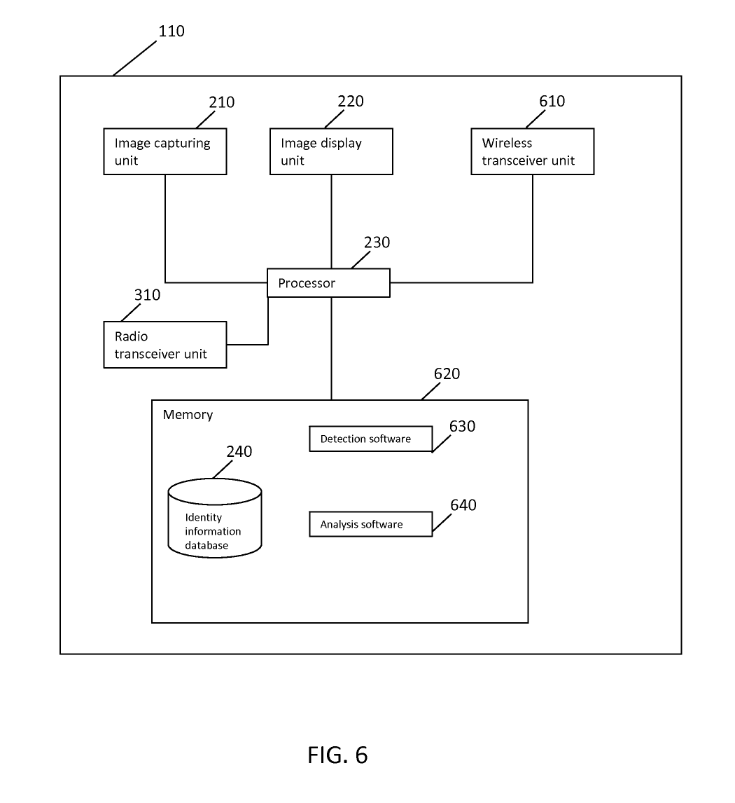

Reference is now made to FIG. 6. FIG. 6 shows an example block diagram 110 of the first electronic device. The first electronic device 110 has the image capturing unit 210, the image display unit 220, a wireless transceiver unit 610, the processor 230, the radio transceiver unit 310 and a memory 520. The image capturing unit 210 (e.g., a camera or scanner) that is configured to capture images, and the image display unit 220 is configured to display the image and content associated with the image to a user. The radio transceiver unit 310 is for example an RF transceiver that is configured to communicate with other devices using RF signals. Thus, the radio receiver 310 enables the first electronic device 110 to read and gather (using RF protocols) information in RFID tags and NFC tags of other electronic devices, such as the second electronic device 130. It should be appreciated that together or separately, the radio transceiver unit 310 and/or the image capturing unit 210 may be referred to as a region detection unit to capture images (e.g., in the example of FIG. 2 above) and/or detect RF detection regions (in the example of FIG. 3 above). The wireless transceiver unit 610 is configured to send and receive wireless information (e.g., wireless data such as packets and messages) to other electronic devices. In one example, the wireless transceiver unit 610 is a radio transceiver unit configured to exchange wireless communications with the second electronic device 130. The image capturing unit 210, image display unit 220, radio transceiver unit 310 and wireless transceiver unit 610 are coupled to or in communication with the processor 230. The processor 230 is, for example, a microprocessor or microcontroller that is configured to execute program logic instructions (i.e., software) for carrying out various operations and tasks of the first electronic device 110, as described above. For example, the processor 230 is configured to execute detection software 630 to detect a detection region (an image, RF detection region, color region, etc.) and analysis software 640 to analyze information obtained from the detection and to determine identity information (and other information) of an electronic device or project. The functions of the processor 230 may be implemented by logic encoded in one or more tangible computer readable storage media or devices (e.g., storage devices, compact discs, digital video discs, flash memory drives, etc. and embedded logic such as an application specific integrated circuit, digital signal processor instructions, software that is executed by a processor, etc.).

The memory 620 may comprise read only memory (ROM), random access memory (RAM), magnetic disk storage media devices, optical storage media devices, flash memory devices, electrical, optical, or other physical/tangible (non-transitory) memory storage devices. The memory 620 stores software instructions for the detection software 630 and the analysis software 640. The memory 620 also stores the identity information database 240, as described above. Thus, in general, the memory 620 may comprise one or more computer readable storage media (e.g., a memory storage device) encoded with software comprising computer executable instructions and when the software is executed (e.g., by the processor 230) it is operable to perform the operations described for the detection software 630 and the analysis software 640, as described herein.

The detection software 630 and the analysis software 640 may take any of a variety of forms, so as to be encoded in one or more tangible computer readable memory media or storage device for execution, such as fixed logic or programmable logic (e.g., software/computer instructions executed by a processor), and the processor 230 may be an ASIC that comprises fixed digital logic or a combination thereof.

For example, the processor 230 may be embodied by digital logic gates in a fixed or programmable digital logic integrated circuit, which digital logic gates are configured to perform the detection software 630 and the analysis software 640. In general the detection software 630 and the analysis software 640 may be embodied in one or more computer readable storage media encoded with software comprising computer executable instructions and when the software is executed operable to perform the operations described herein.

It should be appreciated that the techniques described above in connection with all embodiments may be performed by one or more computer readable storage media that is encoded with software comprising computer executable instructions to perform the methods and steps described herein. For example, the operations performed by the first electronic device 110 and the second electronic device 130 may be performed by one or more computer or machine readable storage media (non-transitory) or device executed by a processor and comprising software, hardware or a combination of software and hardware to perform the techniques described herein.

In summary, a method is provided comprising: at a first device configured to interact with a detection region of a second device, detecting the detection region associated with the second device; obtaining information from the detecting; and analyzing the information to determine identity information of the second device, wherein the identity information comprises information configured to be utilized during pairing of the first device and the second device for wireless communications between the first device and the second device.

In addition, one or more computer readable storage media is provided that is encoded with software comprising computer executable instructions and when the software is executed operable to: detect at a first device a detection region of a second device; obtain information from detecting the detection region; and analyze the information to determine identity information of the second device, wherein the identity information comprises information configured to be utilized during pairing of the first device and the second device for wireless communications between the first device and the second device.

Furthermore, an apparatus is provided comprising: a region detection unit; and a processor coupled to the region detection unit, and further configured to: detect the detection region associated with the second device; obtain information from detecting the detection region; and analyze the information to determine identity information of the second device, wherein the identity information comprises information configured to be utilized during pairing of the first device and the second device for wireless communications between the first device and the second device.

The above description is intended by way of example only. Various modifications and structural changes may be made therein without departing from the scope of the concepts described herein and within the scope and range of equivalents of the claims.

1. A method comprising:
at a first device configured to interact with a detection region of a shoe detecting the detection region associated, with the shoe;
obtaining information from the detecting; and
analyzing the information to determine identity information of a second device embedded within the shoe, wherein the identity information comprises information configured to be utilized during pairing of the first device with the second device for wireless communications between the first device and the second device.

2. The method of claim 1, wherein analyzing comprises determining the identity information of the second device before any wireless communication pairing operation is performed between the first device and the second device such that the first device determines the identity information of the second device before the pairing operation is initialized.

3. The method of claim 1, wherein detecting comprises detecting an image associated with the second device and wherein analyzing comprises analyzing the image to determine the identity information of the second device.

4. The method of claim 1, further comprising:
storing the identity information; and
retrieving the identity information of the second device for use during wireless communication pairing operations between the first device and the second device.

5. The method of claim 4, wherein retrieving comprises retrieving the identity information of the second device for use during a Bluetooth pairing between the first device and the second device.

6. The method of claim 1, wherein detecting comprises detecting at least one of a single dimension bar code or a multi-dimension bar code.

7. The method of claim 1, wherein detecting comprises detecting a near field communication tag region and wherein analyzing comprises analyzing information received from the near field communication tag region to determine the identity information of the second device.

8. The method of claim 1, wherein detecting comprises detecting a radio-frequency identification region and wherein analyzing comprises analyzing information received from the radio-frequency identification region to determine the identity information of the second device.

9. The method of claim 1, wherein detecting comprises detecting a color region of the second device and wherein analyzing comprises analyzing information received from the color region to determine the identity information of the second device.

10. The method of claim 1, wherein analyzing comprises determining identity information that contains information at least one of a unique identifier of the second device and a serial number of the second device, or both.

11. The method of claim 1, wherein analyzing comprises determining product information of an object with which the second device is affixed, attached, housed, embedded or in communication.

12. One or more non-transitory computer readable storage media encoded with software comprising computer executable instructions and when the software is executed operable to:
detect at a first device a detection region of a shoe;
obtain information from detecting the detection region; and
analyze the information to determine identity information of a second device embedded within the shoe, wherein the identity information comprises information configured to be utilized during pairing of the first device with the second device for wireless communications between the first device and the second device.

13. The computer readable storage media of claim 12, wherein the instructions that are operable to analyze comprise instructions that are operable to determine the identity information of the second device before any wireless communication pairing operation is performed between the first device and the second device such that the first device determines the identity information of the second device before the pairing operation is initialized.

14. The computer readable storage media of claim 12, wherein the instructions that are operable to detect comprise instructions that are operable to detect an image associated with the second device and wherein the instructions that are operable to analyze comprise analyzing the image to determine the identity information of the second device.

15. The computer readable storage media of claim 12, wherein the instructions that are operable to detect comprise instructions that are operable to detect a near field communication tag region and wherein the instructions that are operable to analyze comprise instructions that are operable to analyze information received from the near field communication tag region to determine the identity information of the second device.

16. The computer readable storage media of claim 12, wherein the instructions that are operable to detect comprise instructions that are operable to detect a radio-frequency identification region and wherein the instructions that are operable to analyze comprise instructions that are operable to analyze information received from the radio-frequency identification region to determine the identity information of the second device.

17. An apparatus comprising:
a region detection unit; and
a processor coupled to the region detection unit, and further configured to:
detect the detection region of a shoe;
obtain information from detecting the detection region; and
analyze the information to determine identity information of a second device embedded within the shoe, wherein the identity information comprises information configured to be utilized during pairing of the first device with the second device for wireless communications between the first device and the second device.

18. The apparatus of claim 17, wherein the processor is further configured to determine the identity information of the second device before any wireless communication pairing operation is performed between the first device and the second device such that the first device determines the identity information of the second device before the pairing operation is initialized.

19. The apparatus of claim 17, wherein the processor is further configure to detect an image associated with the second device and to analyze the image to determine the identity information of the second device.

20. The apparatus of claim 17, wherein the processor is further configured to detect a radio-frequency identification region and to analyze information received from the radio-frequency identification region to determine the identity information of the second device.
